(19) United States
(12) Patent Application Publication
(10) Pub. No.: US 2006/0257608 A1
(43) Pub. Date: Nov. 16, 2006

(54) Destructible privacy label for curved surfaces

(75) Inventors: Rodney C. Severn, New Lothrop, MI (US); John A. Swords, East Lansing, MI (US)

Correspondence Address: Chriostopher J. Fildes;Fildes & Outland, P.C., Suite 2, 20916 Mack Avenue, Grosse Pointe Woods, MI, 48236, US

(73) Assignee: Tri-State Hospital Supply Corporation

(21) Appl. No.: 11/128,942

(22) Filed: May 13, 2005

(51) Int. Cl. B32B 33/00; G09F 3/00

(52) U.S. Cl. 428/40.1; 428/43; 283/81

(57) ABSTRACT

A destructible privacy label for curved surfaces includes a sheet-like member having an upper surface and an adhesive lower surface. The upper surface is adapted for printing thereon. The sheet-like member includes two segments conjoined about a separation line that defines adjacent segment edges. A plurality of spaced temporary connectors connect the adjacent segment edges. The spaced temporary connectors secure the segments together until a threshold force is applied to the spaced temporary connectors. Removing one of the segments from the other renders indicia applied on the sheet-like member upper surface illegible.

### TECHNICAL FIELD

This invention relates to labels used in connection with patient care with medical objects such as medical records, medical containers, and medical devices and, more particularly, to privacy labels that are easily destructible to insure patient privacy after use.

### BACKGROUND OF THE INVENTION

Health care providers commonly label medical objects such as charts, medical devices, and medication containers associated with a particular patient to ensure that the patient receives their intended medical care. However, the Health Insurance Portability and Accountability Act (HIPAA) requires health care providers to hide a patient's identity before disposing of any medical objects associated with the patient.

Patient identification is commonly accomplished by attaching a one-piece label having an adhesive lower surface adapted to adhere to a medical object and an upper surface for displaying indicia such as a patient's name, social security number, or a barcode. At the conclusion of a medical treatment, i.e. when a labeled medical container such as an intravenous (IV) bag is emptied, the label must be adequately destroyed to make the indicia printed thereon illegible. This requires a health care provider to tear away or adequately cross out the indicia printed on the label to protect a patient's identity before disposing of the medical object.

Further, some labels include label segments. When these labels are placed on curved and/or flexible surfaces, such as the outside surface of a medicine vial, IV bag, or similar, the segments may separate from each other as well as from the surface on which the label is placed. This is undesirable as it may result in premature destruction of the labels.

### SUMMARY OF THE INVENTION

The present invention provides an improved destructible privacy label that may be placed on a curved and/or flexible surface without segments of the label separating from each other. The destructible privacy label of the present invention has greater structural integrity while at the same time is still easily destructible to render indicia/printing on the label illegible. The present invention utilizes spaced temporary connectors, such as micro-ties or similar, to hold the label segments together. Upon application of a threshold force, the spaced temporary connectors break to allow for separation of the label segments from each other.

More particularly, a destructible privacy label for curved surfaces in accordance with the present invention includes a sheet-like member having an upper surface and an adhesive lower surface. The upper surface is adapted for printing thereon. The sheet-like member includes two segments conjoined about a separation line that defines adjacent segment edges. At least one temporary connector connects the adjacent segment edges. The at least one temporary connector secures the segments together until a threshold force is applied to the at least one temporary connector. Removal of one of the segments from the other renders indicia/printing on the sheet-like member upper surface illegible.

In a specific embodiment, the at least one temporary connector may be a micro-tie. The at least one temporary connector may be a plurality of spaced temporary connectors The spaced temporary connectors may be spacedly disposed in groups along the separation line. Each of the groups of spaced temporary connectors may include from one to three spaced temporary connectors. The spaced temporary connectors may be disposed along curves of the separation line. Alternatively, the spaced temporary connectors may be intermittently or randomly disposed along the separation line. The separation line may be a cut line and the separation line may be at least partially sinusoidal-like in shape. The spaced temporary connectors may be disposed at crests of the sinusoidal-like portion of the separation line. Alternatively, there may be no spaced temporary connectors at one end of the separation line. The destructible privacy label may also include a removable release liner contacting the sheet-like member adhesive lower surface.

In an alternative embodiment, a destructible privacy label for curved surfaces in accordance with the present invention includes a sheet-like member having an upper surface and an adhesive lower surface. The upper surface is adapted for printing thereon. The sheet-like member includes a plurality of remainder segments. The sheet-like member further includes at least one removable segment separable from the remainder segments. A plurality of spaced temporary connectors connect the removable segment to the remainder segments. The spaced temporary connectors secure the removable segment to the remainder segments until a threshold force is applied to the spaced temporary connectors. Removal of the removable segment renders indicia/printing applied on the sheet-like member upper surface illegible.

Optionally, at least one of the remainder segments may have a two-dimensional shape chosen from a group of circles, squares, diamonds, octagons, dagger shapes, saw tooth shapes, and island shapes. The spaced temporary connectors may be micro-ties. The spaced temporary connectors may be spacedly disposed in groups. The destructible privacy label may also include a removable release liner contacting the sheet-like member adhesive lower surface.

In yet another embodiment, a destructible privacy label in accordance with the present invention includes a sheet-like member having an upper surface and an adhesive lower surface. The sheet-like member includes at least two conjoined segments, wherein adjacent segments abut each other along a separation line. Each of the separation lines is partially a cut line and partially a perforated line. Optionally, portions of each of the separation lines that are cut lines may be longer in length than portions of each of the separation lines that are perforated lines.

These and other features and advantages of the invention will be more fully understood from the following detailed description of the invention taken together with the accompanying drawings.

### BRIEF DESCRIPTION OF THE DRAWINGS

In the drawings:

FIG. 1 is an exploded perspective view of a destructible privacy label for curved surfaces according to the present invention;

FIG. 1A is an enlarged view of a portion of the destructible privacy label of FIG. 1 showing spaced temporary connectors in greater detail;

FIG. 2 is a sectional elevational view of the destructible privacy label of FIG. 1;

FIG. 3 is a plan view of an alternative embodiment of a destructible privacy label for curved surfaces according to the present invention;

FIG. 4A is plan view of another alternative embodiment of a destructible privacy label for curved surfaces according to the present invention;

FIG. 4B is plan view of another alternative embodiment of a destructible privacy label for curved surfaces according to the present invention;

FIG. 4C is plan view of another alternative embodiment of a destructible privacy label for curved surfaces according to the present invention;

FIG. 4D is plan view of another alternative embodiment of a destructible privacy label for curved surfaces according to the present invention;

FIG. 4E is plan view of another alternative embodiment of a destructible privacy label for curved surfaces according to the present invention;

FIG. 4F is plan view of another alternative embodiment of a destructible privacy label for curved surfaces according to the present invention;

FIG. 4G is plan view of another alternative embodiment of a destructible privacy label for curved surfaces according to the present invention;

FIG. 5 is an environmental view of the destructible privacy label of FIG. 1 attached to a medical object; and

FIG. 6 is the environmental view of the destructible label of FIG. 5 after a segment of a sheet-like member of the label has been removed.

### DETAILED DESCRIPTION OF THE INVENTION

Referring now to the drawings in detail, numeral 10 generally indicates a destructible privacy label for curved surfaces in accordance with the present invention. The destructible privacy label 10 allows for easy destruction of patient identity and personal information indicia applied on a surface of the label prior to disposal of a medical object to which the label is attached. Further, the destructible privacy label 10 includes a structure that ensures the label remains intact until the time at which it is desired for the label to be destroyed.

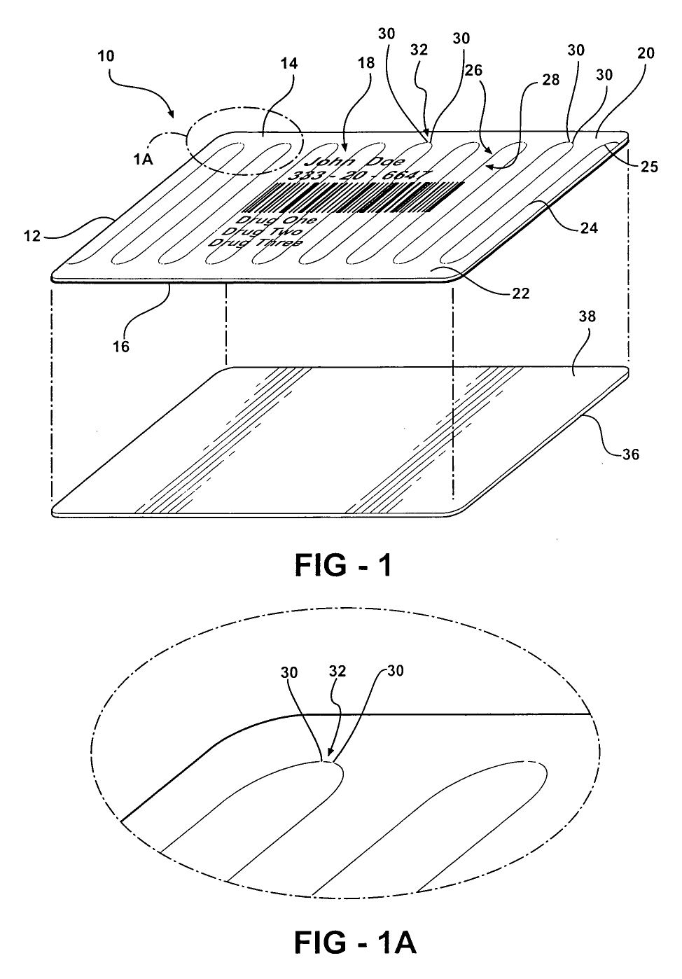

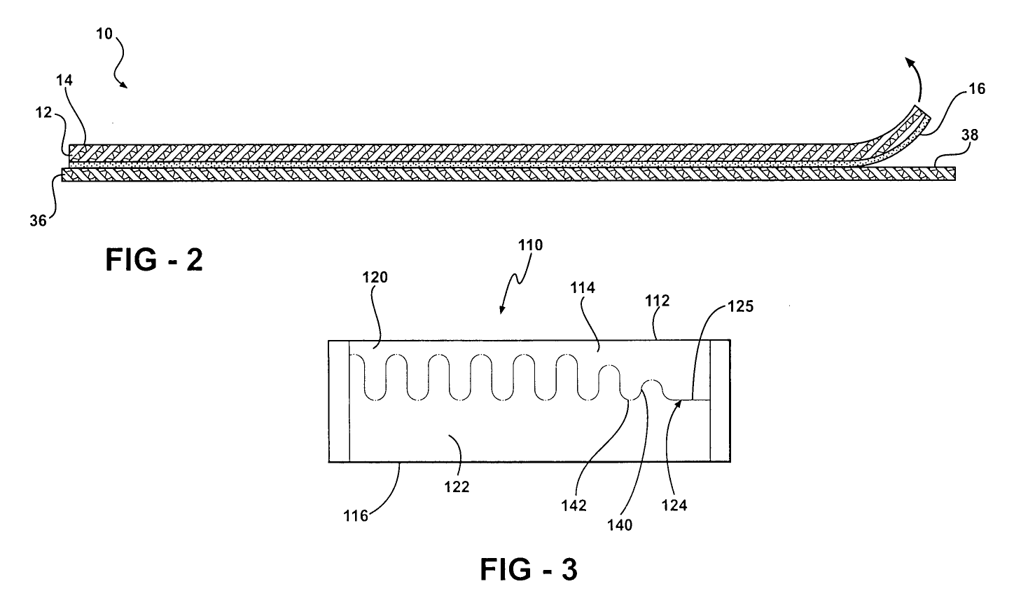

As illustrated in FIGS. 1, 1A and 2, a destructible privacy label for curved surfaces 10 includes a sheet-like member 12 having an upper surface 14 and an adhesive lower surface 16. The upper surface 14 is adapted for printing thereon. The printing may include identification and personal information indicia 18 such as a name, social security number, pharmaceutical names, dosages, bar codes, or similar. The printing of such information may be performed by human or mechanical means. The sheet-like member includes two segments 20, 22 conjoined about a separation line 24 that defines adjacent segment edges 26, 28. A plurality of spaced temporary connectors 30 connect the adjacent segment edges 26, 28. Each spaced temporary connector 30 may be, for example, a small piece of paper/label material connected to the label segments 20, 22 on opposite ends. The spaced temporary connectors 30 secure the segments 20, 22 together until a threshold force is applied to the spaced temporary connectors. Although label 10 is illustrated with a plurality of spaced connectors 30 for discussion purposes, at least one connector is required in accordance with the invention. When connectors 30 are spaced, they may be alternating, intermittently, or randomly disposed. Upon application of such a threshold force, each segment 20, 22 is separable from the other along the separation line 24. Removing one of the segments 20, 22 from the other renders printing/indicia 18 printed and/or applied on the sheet-like member upper surface 14 illegible.

In a specific embodiment, the spaced temporary connectors 30 may be micro-ties. The spaced temporary connectors 30 may be spacedly disposed in groups 32 along the separation line 24. Each of the groups 32 of spaced temporary connectors 30 may include from two to three spaced temporary connectors. The spaced temporary connectors 30 may be disposed along curves of the separation line 24, although the spaced temporary connectors may also be disposed along any desired portion of the separation line. Generally, it is desirable to dispose the spaced temporary connectors 30 along portions of the separation line 24 at which the segment edges 26, 28 are likely to separate from each other prior to the destruction of the label 10. The separation line 24 may be a cut line and may be at least partially sinusoidal-like in shape. The spaced temporary connectors 30 may be disposed at crests of the sinusoidal-like portion of the separation line. Alternatively, there may be no spaced temporary connectors 30 at one end 25 of the separation line. The destructible privacy label 10 may also include a removable release liner 36 contacting the sheet-like member adhesive lower surface 16. The surface 38 of the release liner 36 contacting the sheet-like member adhesive lower surface 16 may be siliconized or similar.

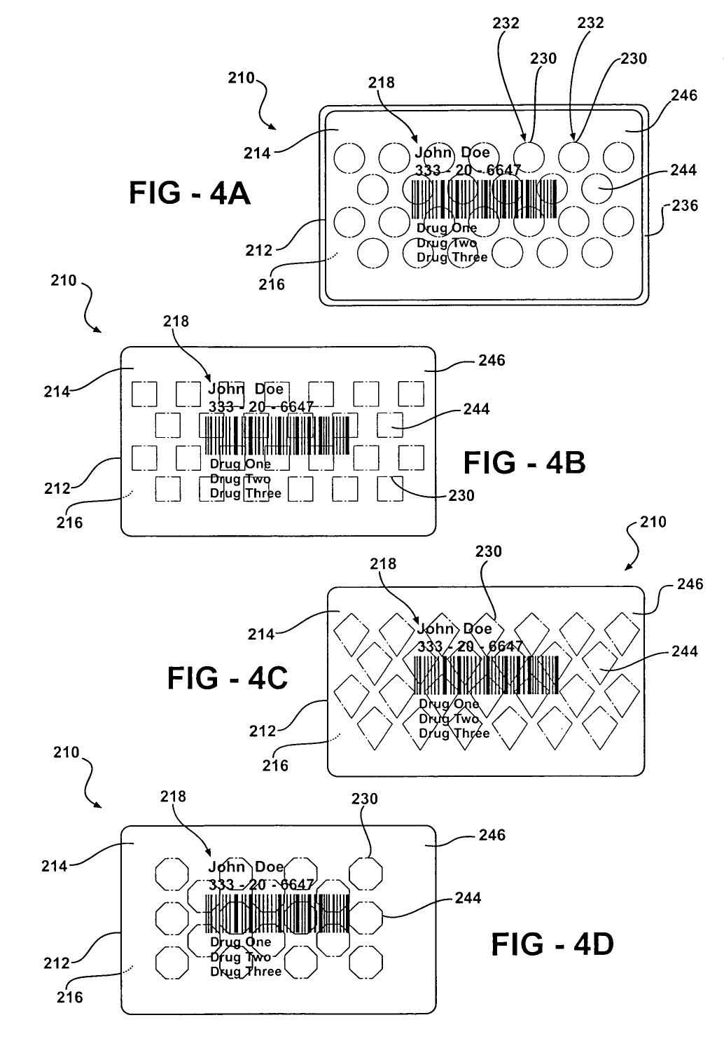

Referring now to FIG. 3, in an alternative embodiment, a destructible privacy label 110 in accordance with the present invention includes a sheet-like member 112 having an upper surface 114 and an adhesive lower surface 116. The sheet-like member 114 includes at least two conjoined segments 120, 122, wherein adjacent segments, such as segments 120, 122, abut each other along a separation line 124. Each of the separation lines 124 is partially a cut line 140 and partially a perforated line 142. The spaces between the perforations of the perforated line 142 form spaced temporary connectors. Optionally, portions of each of the separation lines 124 that are cut lines 140 may be longer in length than portions of each of the separation lines that are perforated lines 142. One end 125 of the separation line 124 may be only a cut line 140.

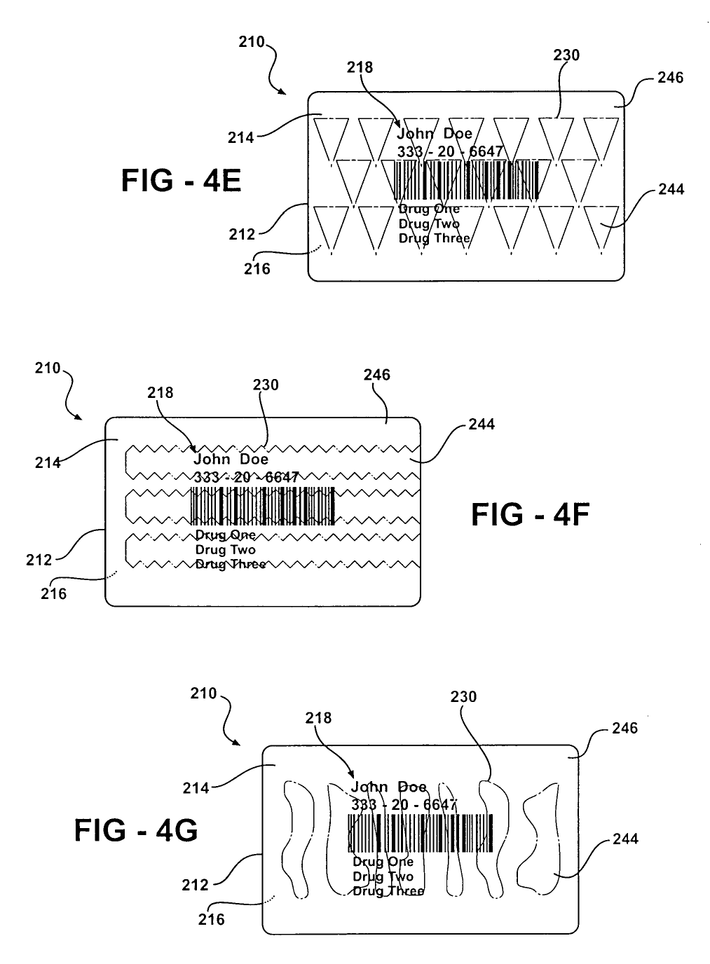

FIGS. 4A-4G illustrate other alternative embodiments of a destructible privacy label for curved surfaces 210 in accordance with the present invention. In these related embodiments, the destructible privacy label 210 includes a sheet-like member 212 having an upper surface 214 and an adhesive lower surface 216. The upper surface 214 is adapted for printing thereon, for example the printing of indicia 218 such as personal and identification information. The sheet-like member 212 includes a plurality of remainder segments 244. The sheet-like member 212 further includes at least one removable segment 246 separable from the remainder segments 244. A plurality of spaced temporary connectors 230 connect the removable segment 246 to the remainder segments 244. The spaced temporary connectors 230 secure the removable segment 246 to the remainder segments 244 until a threshold force is applied to the spaced temporary connectors. Removal of the removable segment 246 renders indicia/printing 218 printed and/or applied on the sheet-like member upper surface 214 illegible.

The remainder segments 244 may be of any size two-dimensional geometrical shape such as circles, squares, diamonds, octagons, dagger shapes, saw tooth shapes, and island shapes. It is only necessary that the remainder segments 244 be of such a size, shape, and location relative to each other that removal of the removable segment 246 causes indicia/printing 218 printed on the sheet-like member upper surface 214 incomplete and therefore, illegible. FIG. 4A depicts remainder segments 244 that are circles. FIG. 4B depicts remainder segments 244 that are squares. FIG. 4C depicts remainder segments 244 that are diamonds. FIG. 4D depicts remainder segments 244 that are octagons. FIG. 4E depicts remainder segments 244 that are dagger shapes. FIG. 4F depicts remainder segments 244 that are saw tooth shapes. FIG. 4G depicts remainder segments 244 that are island shapes.

Optionally, the spaced temporary connectors 230 may be micro-ties. The spaced temporary connectors 230 may also be spacedly disposed in groups 232 (see, for example, FIG. 4A). The destructible privacy label 210 may further include a removable release liner 236 contacting the sheet-like member adhesive lower surface 216, as also shown by example in FIG. 4A.

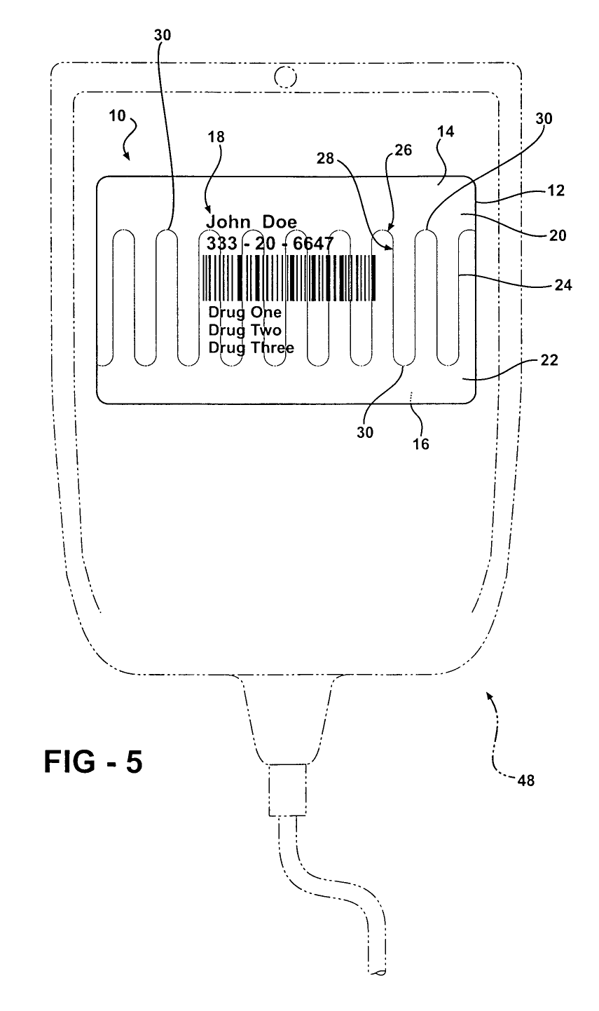

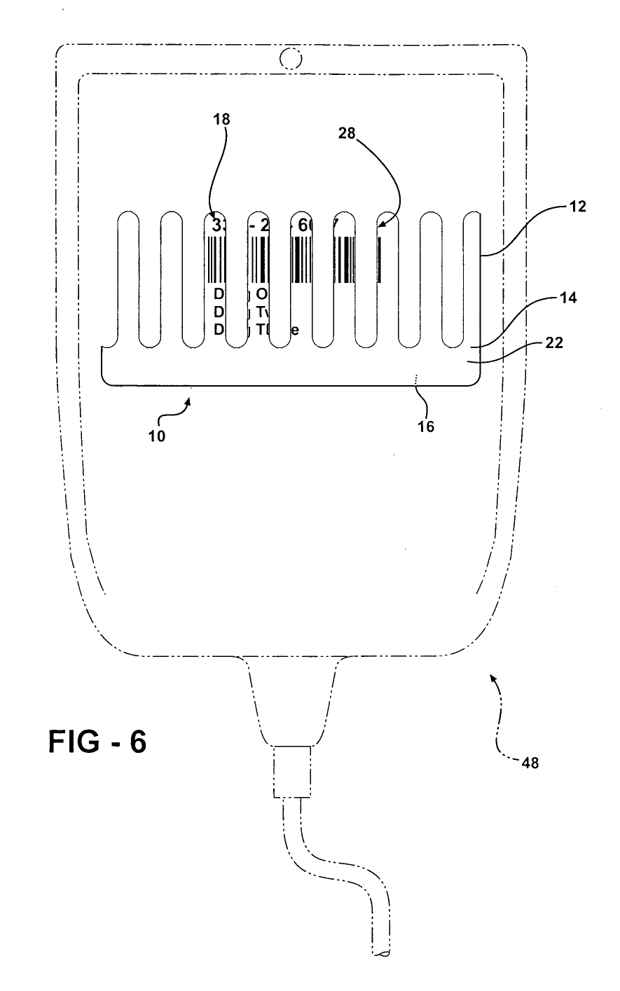

Referring now to FIGS. 1, 2, 5, and 6, indicia 18 such as the identification and personal information described above may be printed or applied on the upper surface 14 of the sheet-like member 12. As an example, the printing may be performed at a hospital by hospital staff, either manually or with a printing device, to print identification and personal information of a patient onto the label. The removable release liner 36, if present, may then be removed from the sheet-like member adhesive lower surface 16. The adhesive lower surface 16 may then be placed on an object 48 such as a medical IV bag, a medical record sheet, a medical container, a medical instrument, a medical device, or other similarly related object. In FIGS. 5 and 6, the object 48 is shown as an IV bag. Placing the destructible label 10 on the object 48 associates the object with a patient's identity and personal information represented by the indicia 18 on the sheet-like member upper surface 14.

During application of the label 10 and after the label 10 has been applied to an object 48, the spaced temporary connectors 30 ensure that the segments 20, 22 are secured together. If the label 10 is bent, or if the object 48 to which the label is attached is flexed, the label segments 20, 22 remain connected. At such time that the association between the indicia 18 and the object 48 is no longer needed, or prior to disposal of the object 48, one of the segments 20 may be removed from the other segment 22 and from the object 48. To remove one segment 20 from the other segment 22, a threshold force is applied to the spaced temporary connectors 30, for example, by gripping the edge of one of the segments 20 and pulling away from the object 48. This separates the connection between the spaced temporary connectors 30 and the label segments 20, 22. Removing the segment 20 thereby renders the indicia 18 printed on the sheet-like member upper surface 14 illegible. This effectively protects the privacy of the patient's identity and personal information represented by the indicia 18.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A destructible privacy label comprising:
a sheet-like member having an upper surface and an adhesive lower surface;
said upper surface adapted for printing thereon;
said sheet-like member comprising two segments conjoined about a separation line that defines adjacent segment edges; and
at least one temporary connector connecting said adjacent segment edges;
wherein said at least one temporary connector secures said segments together until a threshold force is applied to the at least one temporary connector, and removing one of said segments from the other renders indicia applied on said sheet-like member upper surface illegible.

2. The destructible privacy label of claim 1, wherein said at least one temporary connector is a micro-tie.

3. The destructible privacy label of claim 1, wherein the at least one temporary connector is a plurality of spaced temporary connectors.

4. The destructible privacy label of claim 3, wherein said spaced temporary connectors are spacedly disposed in groups along said separation line.

5. The destructible privacy label of claim 4, wherein each of said groups of spaced temporary connectors includes from one to three spaced temporary connectors.

6. The destructible privacy label of claim 3, wherein said spaced temporary connectors are disposed along curves of the separation line.

7. The destructible privacy label of claim 3, wherein said spaced temporary connectors are intermittently disposed along the separation line.

8. The destructible privacy label of claim 3, wherein said spaced temporary connectors are randomly disposed along the separation line.

9. The destructible privacy label of claim 3, wherein said separation line is at least partially sinusoidal-like in shape.

10. The destructible privacy label of claim 9, wherein said temporary connectors are disposed at crests of the sinusoidal-like portion of said separation line.

11. The destructible privacy label of claim 1, wherein there are no temporary connectors at one end of said separation line.

12. The destructible privacy label of claim 1, wherein said separation line is a cut line.

13. The destructible privacy label of claim 1, further including a removable release liner contacting said sheet-like member adhesive lower surface.

14. A destructible privacy label comprising:
a sheet-like member having an upper surface and an adhesive lower surface, said upper surface being adapted for printing thereon;
said sheet-like member including a plurality of remainder segments;
said sheet-like member further including at least one removable segment separable from said remainder segments; and
a plurality of spaced temporary connectors connecting said removable segment to said remainder segments;
wherein said spaced temporary connectors secure said removable segment to said remainder segments until a threshold force is applied to the spaced temporary connectors, and removing said removable segment renders indicia applied on said sheet-like member upper surface illegible.

15. The destructible privacy label of claim 14, wherein at least one of said remainder segments has a two-dimensional shape chosen from a group of circles, squares, diamonds, octagons, dagger shapes, saw tooth shapes, and island shapes.

16. The destructible privacy label of claim 14, further including a removable release liner contacting said sheet-like member adhesive lower surface.

17. The destructible privacy label of claim 14, wherein said spaced temporary connectors are micro-ties.

18. The destructible privacy label of claim 14, wherein said spaced temporary connectors are spacedly disposed in groups.

19. A destructible privacy label comprising:
a sheet-like member having an upper surface and an adhesive lower surface;
said sheet-like member including at least two conjoined segments, wherein adjacent segments abut each other along a separation line;
each of said separation lines being partially a cut line and partially a perforated line.

20. The destructible privacy label of claim 19, wherein portions of each of said separation lines that are cut lines are longer in length than portions of each of said separation lines that are perforated lines.
